(19) United States
(12) Patent Application Publication
(10) Pub. No.: US 2025/0028983 A1
(43) Pub. Date: Jan. 23, 2025

(54) METHOD FOR LIGHT WEIGHTING OF ARTIFICIAL INTELLIGENCE MODEL, AND COMPUTER PROGRAM RECORDED ON RECORD-MEDIUM FOR EXECUTING METHOD THEREFOR

(71) Applicant: MOBILTECH, Seoul (KR)

(72) Inventors: Jae Seung KIM, Seoul (KR); Hee Jin YOON, Gunpo-si (KR)

(21) Appl. No.: 18/491,298

(22) Filed: Oct. 20, 2023

(30) Foreign Application Priority Data
Jul. 21, 2023 (KR) 10-2023-0095430

(51) Int. Cl. G06N 5/04; G06N 3/082

(52) U.S. Cl. CPC G06N 5/04; G06N 3/082

(57) ABSTRACT

A method of lightweighting an artificial intelligence model can increase inference speed while maintaining accuracy of the artificial intelligence model for detecting objects in an image captured by a camera as much as possible. The method may include the steps of: pruning an artificial intelligence model machine-learned using a first data set, by a data processing device; quantizing the pruned artificial intelligence model, by the data processing device; and learning the artificial intelligence model by imitating another artificial intelligence model previously trained using a second data set including a larger amount of data than the first data set, by the data processing device.

### CROSS-REFERENCE TO RELATED APPLICATIONS

This application claims the priority of Korean Patent Application No. 10-2023-0095430 filed on Jul. 21, 2023, in the Korean Intellectual Property Office, the disclosure of which is incorporated herein by reference.

### BACKGROUND OF THE INVENTION

### Field of the Invention

The present invention relates to an artificial intelligence model, and more specifically, to a method of lightweighting an artificial intelligence model, which can increase inference speed while maintaining accuracy of the artificial intelligence model for detecting objects in an image captured by a camera as much as possible, and a computer program recorded on a recording medium to execute the method.

### Background of the Related Art

Automatic driving of a vehicle refers to a system that allows the vehicle to drive by making its own decisions. The automatic driving like this may be divided into gradual stages from non-automation to full automation according to a degree that the system involves in driving and a degree that the driver controls the vehicle. Generally, the stages of automatic driving are divided into six levels classified by Society of Automotive Engineers (SAE) International. According to the six levels classified by the Association of Automotive Engineers International, level 0 is non-automation, level 1 is driver assistance, level 2 is partial automation, level 3 is conditional automation, level 4 is high automation, and level 5 is full automation.

Automatic driving is performed through a mechanism of perception, localization, path planning, and control. In addition, various companies are developing to implement the perception and the path planning of the automatic driving mechanism using artificial intelligence (AI).

For the automatic driving like this, various information on the road should be collected in advance. However, in reality, it is not easy to collect and analyze massive amounts of information in real time using only sensors of a vehicle. Accordingly, in order to realize the automatic driving, high-definition road maps that can provide various information needed for actual automatic driving are essential.

Here, the high-definition road map refers to a three-dimensional electronic map constructed with information on the roads and surrounding terrain with an accuracy of ±25 cm. Such a high-definition road map is a map including precise information such as road width, road curvature, road slope, lane information (dotted lines, solid lines, stop lines, etc.), surface type information (crosswalks, speed bumps, shoulders, etc.), road mark information, sign information, and facility information (traffic lights, curbs, manholes, etc.), and the like, in addition to information that a general electronic map has (node information and link information needed for route guidance).

In order to create such a high-definition road map, various related data such as Mobile Mapping System (MMS), aerial photography information, and the like are required.

Particularly, the MMS is mounted on a vehicle to measure the location of terrain features around the road and obtain visual information while the vehicle drives. That is, the MMS may be constructed on the basis of information collected by the Global Positioning System (GPS), Inertial Navigation System (INS), Inertial Measurement Unit (IMU), cameras for collecting the shape and information on the terrain features, LiDAR (Light Detection and Ranging), and other sensors.

Such a high-definition road map is configured to include various objects such as buildings, facilities, roads, and the like. Here, although information on the buildings or roads included in the high-definition road map is not added or deleted frequently, facilities are frequently added or deleted.

Accordingly, it needs to provide a method capable of identifying and managing the status of facilities on a high-definition road map with high accuracy, and updating the stored map according to the facility status.

In addition, images collected in the process of creating a high-definition road map include dynamic objects such as vehicles, as well as static objects such as buildings, facilities, roads, and the like. Here, the dynamic objects correspond to noise in the high-definition road map. Therefore, a method that can remove noise such as the dynamic objects on the high-definition road map is needed.

Meanwhile, an artificial intelligence model for identifying objects in an image to grasp the status of facilities has a problem of essentially requiring expensive devices such as a Graphics Processing Unit (GPU).

The present invention is a technique developed with support from the Ministry of Land, Infrastructure and Transport and the Korea Agency for Infrastructure Technology Advancement (Project No. RS-2021-KA160637).
(Patent Document 1) Korean Patent Publication No. 10-2283868, ‘Road precision map production system for autonomous driving’, (registered on Jul. 26, 2021)

### SUMMARY OF THE INVENTION

Therefore, the present invention has been made in view of the above problems, and it is an object of the present invention to provide a method of lightweighting an artificial intelligence model, which can increase inference speed while maintaining accuracy of the artificial intelligence model for detecting objects in an image captured by a camera as much as possible.

Another object of the present invention is to provide a computer program recorded on a recording medium to execute a method of lightweighting an artificial intelligence model, which can increase inference speed while maintaining accuracy of the artificial intelligence model for detecting objects in an image captured by a camera as much as possible.

The technical problems of the present invention are not limited to the technical problems mentioned above, and unmentioned other technical problems will be clearly understood by those skilled in the art from the following description.

To accomplish the above object, according to one aspect of the present invention, there is provided a method of lightweighting an artificial intelligence model, which can increase inference speed while maintaining accuracy of the artificial intelligence model for detecting objects in an image captured by a camera as much as possible. The method may include the steps of: pruning an artificial intelligence model machine-learned using a first data set, by a data processing device; quantizing the pruned artificial intelligence model, by the data processing device; and learning the artificial intelligence model by imitating another artificial intelligence model previously trained using a second data set including a larger amount of data than the first data set, by the data processing device.

Specifically, the pruning step includes converting a corresponding weight to ‘0’ when a weight value of each layer included in the artificial intelligence model is smaller than or equal to a preset value.

The pruning step includes analyzing sensitivity of the artificial intelligence model, and determining a threshold for the weight value by multiplying a sensitivity parameter according to the analyzed sensitivity by a standard deviation of a weight value distribution of the artificial intelligence model.

The pruning step includes deriving the sensitivity parameter by performing iterative pruning by applying a threshold preset for the weight to the artificial intelligence model.

The artificial intelligence model is configured as a “floating point 32-bit type”, and the quantizing step includes converting the artificial intelligence model into a “signed 8-bit integer type”.

The pruning step includes converting the weight of the artificial intelligence model and the input between layers into a value of binary form according to a sign.

The quantizing step includes quantizing a plurality of weights of the artificial intelligence model, and quantizing activation at a time point of inference.

The quantizing step includes quantizing a plurality of weights of the artificial intelligence model, and previously quantizing the plurality of weights and activations of the artificial intelligence model.

The quantizing step includes determining a weight and performing quantization at the same time by simulating in advance an effect of applying quantization during inference at a time point when learning of the artificial intelligence model is progressed.

The learning step includes calculating a loss by comparing outputs of the artificial intelligence model and another artificial intelligence model, and learning the artificial intelligence model so that the calculated loss is minimized.

The learning step includes learning by imitating another artificial intelligence model on the basis of a loss function according to the equation shown below.

$$TotalLoss = ( 1 - α ) {L}_{CE} ( σ ( {Z}_{s} ) , \hat{y} ) + 2 α {T}^{e} {L}_{CE} ( σ ( \frac{{Z}_{s}}{T} ) , σ ( \frac{{Z}_{s}}{T} ) ) \qquad [ Equation ]$$

(Here, L_{CE} denotes a cross entropy loss, σ denotes Softmax, Zₛ denotes output logits of the artificial intelligence model, Zₜ denotes output logits of another artificial intelligence model, ŷ denotes the ground truth (one-hot), α denotes a balancing parameter, and T denotes a temperature hyperparameter.)

The artificial intelligence model is an artificial intelligence model for detecting objects on an image captured by the camera.

To accomplish the above object, the present invention proposes a computer program recorded on a recording medium to execute the method. The computer program may be combined with a computing device configured to include a memory, a transceiver, and a processor that processes instructions loaded on the memory. In addition, the computer program may be a computer program recorded on a recording medium to execute the steps of: pruning an artificial intelligence model machine-learned using a first data set, by the processor; quantizing the pruned artificial intelligence model, by the processor; and learning the artificial intelligence model by imitating another artificial intelligence model previously trained using a second data set including a larger amount of data than the first data set, by the processor.

Other specific details of the embodiments are included in the detailed description and drawings.

According to the embodiments of the present invention, inference speed can be increased, while maintaining accuracy of inference as much as possible, by lightweighting the artificial intelligence model for detecting objects in an image captured by a camera, through the process of pruning, quantizing, and learning by imitation.

The effects of the present invention are not limited to the effects mentioned above, and unmentioned other effects may be clearly understood by those skilled in the art from the description of the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a view showing the configuration of a data generation system according to an embodiment of the present invention.

FIG. 2 is a view showing the logical configuration of a data processing device according to an embodiment of the present invention.

FIG. 3 is a view showing the hardware configuration of a data processing device according to an embodiment of the present invention.

FIG. 4 is a flowchart illustrating a facility update method according to an embodiment of the present invention.

FIG. 5 is a flowchart illustrating a facility management method according to an embodiment of the present invention.

FIG. 6 is a flowchart illustrating a facility management method according to another embodiment of the present invention.

FIG. 7 is a flowchart illustrating a noise removing method according to an embodiment of the present invention.

FIG. 8 is a flowchart illustrating a method of lightweighting an artificial intelligence model according to an embodiment of the present invention.

FIGS. 9 to 11 are exemplary views for explaining a facility update method according to an embodiment of the present invention.

FIGS. 12 to 14 are exemplary views for explaining a facility management method according to an embodiment of the present invention.

FIGS. 15 and 16 are exemplary views for explaining a facility management method according to another embodiment of the present invention.

FIGS. 17 and 18 are exemplary views for explaining a noise removing method according to an embodiment of the present invention.

### DETAILED DESCRIPTION OF THE PREFERRED EMBODIMENT

It should be noted that the technical terms used in this specification are only used to describe specific embodiments and are not intended to limit the present invention. In addition, the technical terms used in this specification should be interpreted as a meaning commonly understood by those of skilled in the art, unless specifically defined otherwise in this specification, and should not be interpreted in an excessively inclusive or reduced meaning. In addition, when the technical terms used in this specification are incorrect technical terms that do not accurately express the spirit of the present invention, they should be replaced with technical terms that those skilled in the art can correctly understand. In addition, general terms used in the present invention should be interpreted as defined in a dictionary or according to the context, and should not be interpreted in an excessively reduced meaning.

In addition, singular expressions used in this specification include plural expressions unless the context clearly indicates otherwise. In this application, terms such as ‘configured of’ or ‘having’ should not be interpreted as necessarily including all of the various components or steps described in the specification, and should be interpreted as including some of the components or steps among them, or further including additional components or steps.

In addition, although the terms including ordinal numbers such as first, second, and the like used in this specification may be used to describe various components, the components should not be limited by the terms. The terms are used only for the purpose of distinguishing one component from another. For example, a first component may be named as a second component without departing from the scope of the present invention, and similarly, a second component may also be named as a first component.

When a component is referred to as being ‘connected’ or ‘coupled’ to another component, although it may be directly connected or coupled to another component, other components may exist between the components. On the contrary, when a component is referred to as being ‘directly connected’ or ‘directly coupled’ to another component, it should be understood that no other component exists therebetween.

Hereinafter, preferred embodiments according to the present invention will be described in detail with reference to the accompanying drawings, and the same or similar components are given the same reference numerals regardless of drawing symbols, and redundant description thereof will be omitted. In addition, when it is determined in describing the present invention that a detailed description of a related known technology may obscure the gist of the present invention, the detailed description will be omitted. In addition, it should be noted that the accompanying drawings are only for easy understanding of the spirit of the present invention, and it should not be construed as limiting the spirit of the present invention by the accompanying drawings. The spirit of the present invention should be interpreted as extending to all changes, equivalents, and substitutes, in addition to the accompanying drawings.

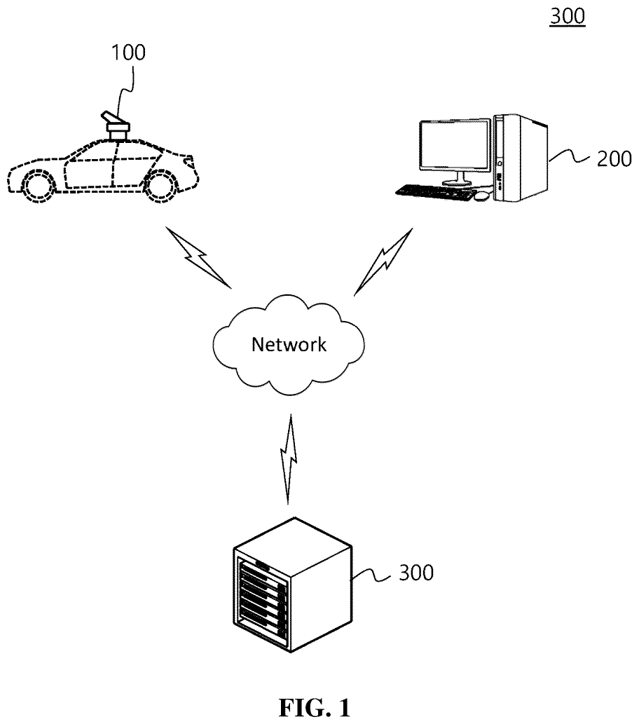

FIG. 1 is a view showing the configuration of a data generation system according to an embodiment of the present invention.

Referring to FIG. 1, a data generation system 300 according to an embodiment of the present invention may include a data collection device 100, a data generation device 200, and a data processing device 300.

Since the components of the data generation system according to an embodiment are only functionally distinguished components, two or more components may be implemented to be integrated in an actual physical environment, or one component may be implemented to be separated in an actual physical environment.

Describing each of the components, the data generation system 100 may be mounted on a vehicle to collect data for creating a map or for learning a learning model for creating a map.

The data generation system 100 may be configured to include one or more among a LiDAR, a camera, a radar, an Inertial Measurement Unit (IMU), and a Global Positioning System (GPS). However, it is not limited thereto, and sensors capable of sensing various information to create a map may be applied.

That is, the data collection device 100 may acquire point cloud data from the LiDAR and an image captured by the camera. In addition, the data collection device 100 may acquire information related to location and pose from an inertial measurement device, GPS, or the like.

Here, the LiDAR may emit laser pulses around the vehicle, detect light reflected and returned from objects located around the vehicle, and generate point cloud data corresponding to a three-dimensional image of around the vehicle.

The camera may acquire images of a space collected from the LiDAR around the LiDAR. The camera may include any one among a color camera, a near infrared (NIR) camera, a short wavelength infrared (SWIR) camera, and a long wave length infrared (LWIR) camera.

The inertial measurement device is configured of an acceleration sensor and an angular velocity sensor (gyroscope), and some inertial measurement devices may also include a magnetometer, and may sense change in acceleration according to change in the movement of the data collection device 100.

The GPS may receive signals transmitted from artificial satellites and measure the location of the data collection device 100 using triangulation.

The data collection device 100 may be installed in a vehicle or an aviation device. For example, the data collection device 100 may be installed on the upper part of the vehicle to collect point cloud data or images of the surroundings, or may be installed on the lower part of the aviation device to collect point cloud data or images of objects on the ground from the air.

In addition, the data collection device 100 may transmit the collected point cloud data or images to the data generation device 200.

As a next configuration, the data generation device 200 may receive the point cloud data acquired by the LiDAR and the image captured by the camera from the data collection device 100.

The data generation device 200 may create a map on the basis of the point cloud data and image received from the data collection device 100.

Specifically, the data generation device 200 may arrange the point cloud data on the world coordinate system by performing calibration on the point cloud data and the image, and assign a color for the pixel of the image corresponding to the coordinates of each arranged point.

Any device capable of transmitting and receiving data to and from the data collection device 100 and the data processing device 300, and performing operation based on the transmitted and received data may be accepted as the data generation device 200 having such characteristics. For example, the data processing device 300 may be any one of fixed-type computing devices such as a desktop, a workstation, and a server, but it is not limited thereto.

As a next configuration, the data processing device 300 may process the map created by the data generation device 200.

Meanwhile, although the data generation device 200 and the data processing device 300 are described as separate components, they may be implemented to be integrated with each other in an actual physical environment.

Characteristically, according to an embodiment of the present invention, the data processing device 300 may receive point cloud data acquired by a LiDAR installed on a vehicle traveling on a route on a previously stored reference map and an image captured through a camera, and identify an object corresponding to a facility on the basis of the received point cloud data and image. In addition, the data processing device 300 may update information on an object on the reference map by matching the identified object with the reference map.

According to another embodiment of the present invention, the data processing device 300 may receive point cloud data acquired by the LiDAR and an image captured by the camera, identify a preset object from the image, and delete a point cloud corresponding to the object identified from the image from the point cloud data. In addition, the data processing device 300 may create a map on the basis of the point cloud data from which a point cloud corresponding to the object is deleted.

According to another embodiment of the present invention, the data processing device 300 may identify an object corresponding to a preset facility in the image captured by the camera and process the image of the identified object. In addition, the data processing device 300 may determine whether the object corresponding to the processed image is damaged.

According to another embodiment of the present invention, the data processing device 300 may perform pruning on an artificial intelligence model machine-learned using a first data set, and quantize the pruned artificial intelligence model. In addition, the data processing device 300 may learn the artificial intelligence model by imitating another artificial intelligence model previously trained using a second data set including a larger amount of data than the first data set.

According to another embodiment of the present invention, the data processing device 300 may identify an object corresponding to a preset facility in the image captured by the camera and recognizes text included in the identified object. In addition, the data processing device 300 may identify the type of a facility corresponding to the identified object on the basis of the recognized text.

Meanwhile, although various embodiments of the present invention have been described as being separated from each other to perform their own functions, the present invention is not limited thereto, and the functions may be applied in combination with each other.

Any device capable of transmitting and receiving data to and from the data collection device 100 and the data generation device 200, and performing operation based on the transmitted and received data may be accepted as the data processing device 300 having such characteristics. For example, the data processing device 300 may be any one of fixed-type computing devices such as a desktop, a workstation, and a server, but it is not limited thereto.

The data collection device 100, the data generation device 200, and the data processing device 300 as described above may transmit and receive data using a network combining one or more among a security circuit, a public wired communication network, and a mobile communication network directly connecting the devices.

For example, the public wired communication network may include Ethernet, x Digital Subscriber Line (xDSL), Hybrid Fiber Coax (HFC), and Fiber-To-The-Home (FTTH), but is not limited thereto. In addition, the mobile communication network may include Code Division Multiple Access (CDMA), Wideband CDMA (WCDMA), High Speed Packet Access (HSPA), Long Term Evolution (LTE), and 5th generation mobile telecommunication, but is not limited thereto.

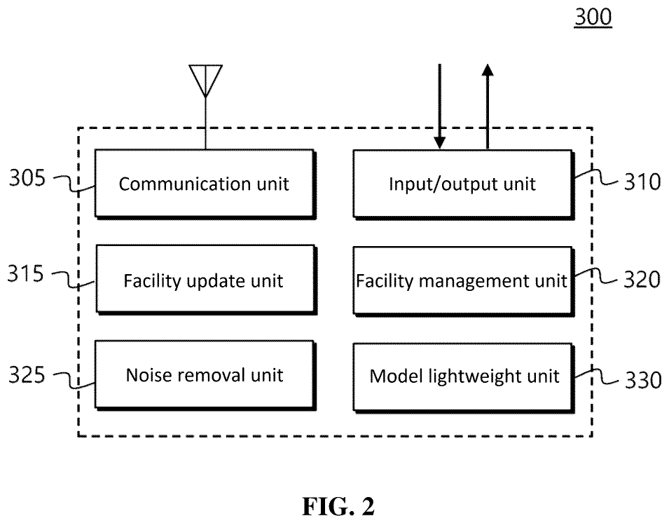

FIG. 2 is a view showing the logical configuration of a data processing device according to an embodiment of the present invention.

Referring to FIG. 2, the data processing device 300 according to an embodiment of the present invention may be configured to include a communication unit 305, an input/output unit 310, a facility update unit 315, a facility management unit 320, a noise removal unit 325, and a model lightweight unit 330.

Since the components of the data processing device 300 merely represent functionally distinguished components, two or more components may be implemented to be integrated with each other in an actual physical environment, or one component may be implemented to be separated into two or more in an actual physical environment.

Describing each of the components, the communication unit 305 may transmit and receive data to and from the data collection device 100 and the data generation device 200. Specifically, the communication unit 305 may receive point cloud data acquired by the LiDAR and images captured through the camera from the data collection device 100 or the data generation device 200. In addition, the communication unit 305 may receive a created map from the data generation device 200 and receive a learning model generated for object detection.

As a next configuration, the input/output unit 310 may receive a signal from a user through a user interface (UI) or output an operation result to the outside. Specifically, the input/output unit 310 may output facility status information, updated maps, and the like.

As a next configuration, the facility update unit 315 may acquire facility status in a driving section from the camera mounted on a vehicle traveling on a route on the map and update the facilities on the map according to the facility status. For example, the facilities may include signs, traffic lights, and the like that exist to be adjacent to roads.

To this end, the facility update unit 315 may receive point cloud data acquired by the LiDAR installed on the vehicle traveling on a route on the reference map and images simultaneously captured through the camera.

Next, the facility update unit 315 may identify an object corresponding to the facility on the basis of the received image.

Specifically, the facility update unit 315 may set a bounding box for an area corresponding to an object in the received image. At this point, the facility update unit 315 may set a bounding box for an area corresponding to an object in the received image on the basis of machine-learned artificial intelligence (AI) on the basis of a previously stored object model.

Here, the bounding box is an area for specifying an object corresponding to a facility among the objects included in the image. The bounding box like this may have a rectangular or polygonal shape, and it is not limited thereto.

Next, the facility update unit 315 may collect point clouds included in the bounding box by projecting the point cloud data onto the image. That is, the facility update unit 315 may collect the points included in the bounding box by projecting the point cloud data acquired by the LiDAR through calibration of the camera and the LiDAR onto the image. At this point, the facility update unit 315 may accumulate and store the points included in the bounding box for a plurality of images received successively.

In addition, the facility update unit 315 may classify the collected point clouds and perform clustering in units of objects. That is, the facility update unit 315 may cluster the collected point clouds in units of objects on the basis of point attributes including one among GPS coordinates, density, and class name.

Meanwhile, before performing the clustering, the facility update unit 315 may sort the point clouds included in the bounding box on the basis of a value of distance from the LiDAR and filter noise points on the basis of density of the sorted points. That is, the facility update unit 315 may classify the point clouds corresponding to an actual object on the basis of density of the points included in the bounding box, and determine and remove remaining points as outliers.

In addition, since a facility such as a sign has high reflectivity, points corresponding to the facility appear to have relatively high intensity. Accordingly, the facility update unit 315 may filter noise points on the basis of the intensity of the point clouds included in the bounding box. That is, the facility update unit 315 may classify and filter the points with an intensity lower than a preset value among the point clouds included in the bounding box as noise points.

Meanwhile, in performing the clustering, the facility update unit 315 may generate at least one first cluster instance by applying a Euclidean clustering algorithm to the collected point clouds. That is, the facility update unit 315 may perform clustering on the basis of a Euclidean distance according to the equation shown below.

$$d ( x , y ) = \sqrt{{( {x}_{1} - {y}_{1} )}^{2} + ⋯ + {( {x}_{p} - {y}_{p} )}^{2}} \qquad [ Equation ]$$

(Here, x and y include arbitrary two points included inside the bounding box.)

At this point, the facility update unit 315 may identify the at least one generated first cluster instance as an object.

It is not limited thereto, and the facility update unit 315 may generate at least one second cluster instance on the basis of class names of the points included in the at least one generated first cluster instance, and identify the newly generated second cluster instance as an object. That is, the facility update unit 315 may calculate a score value of at least one first cluster instance for each class name, and when the calculated score value is greater than or equal to a preset value, it may be regarded as at least one second cluster instance. For example, the facility update unit 315 may calculate a score value for each class name, and when the ratio of the score value is 0.1 or higher, it may be regarded as a second cluster instance.

In addition, the facility update unit 315 may generate at least one third cluster instance for each of the second cluster instances by applying the Euclidean clustering algorithm.

In addition, the facility update unit 315 may identify the at least one generated third cluster instance as an object. That is, the facility update unit 315 may set a representative point representing each of the third cluster instances, extract coordinates corresponding to the representative point, and identify the coordinates of the object. For example, the facility update unit 315 may set a point having the highest intensity among a plurality of points corresponding to each of the third cluster instances as the representative point.

In this way, the facility update unit 315 may more clearly distinguish adjacent facilities from each other through step-by-step clustering of the collected point clouds, and intuitively confirm a process for identifying the facilities.

The facility update unit 315 may update information on an object on the reference map by matching the identified object with the object on the reference map, and may give a status value according to new, delete, move, and change to the object on the updated reference map. That is, the facility update unit 315 may support by storing together the status value such as whether a corresponding facility is new or deleted to make facility management easy, while updating the facility status on the reference map.

As a next configuration, the facility management unit 320 may detect a facility through the image captured by the camera mounted on the vehicle traveling on the road, determine whether the detected facility is damaged, and manage the facility.

To this end, the facility management unit 320 may identify an object corresponding to a preset facility on the image captured by the camera.

Here, the facility may be a median barrier installed on the road. The median barrier may be configured of vertical bars spaced apart from each other at regular intervals along the center line and horizontal bars connecting a pair of adjacent vertical bars. Meanwhile, in the following description, a pair of vertical bars and at least one horizontal bar connecting the pair of vertical bars will be described as one median barrier.

Meanwhile, it is stipulated to mandatorily install median barriers on the roads of four or more lanes. Accordingly, the facility management unit 320 may identify a road on the image and identify an object when the number of lanes on the identified road is more than a preset number. Therefore, the facility management unit 320 may shorten the time required for identifying an object by selectively extracting only images in which median barriers are expected to exist.

Specifically, the facility management unit 320 may set a region of interest (ROI) inside the image. At this point, the facility management unit 320 may set a rectangle of a preset size, including a specific point located at the bottom left of the image as the bottom left vertex, as a region of interest. That is, the camera acquires an image of the front side of the vehicle driving on the road. Accordingly, due to the characteristics of domestic roads, the median barrier is located at the bottom left of the image. Accordingly, the facility management unit 320 may reduce the amount of calculation according to specifying a bounding box by specifying the bottom left of the image as a region of interest since the entire image is not considered. Meanwhile, the facility management unit 320 may set the bottom right as a region of interest when the present invention is used in foreign countries where the road direction is opposite to that of Korea.

Thereafter, the facility management unit 320 may perform segmentation inside the set region of interest and specify at least one bounding box corresponding to an object. That is, the facility management unit 320 may set a bounding box for an area corresponding to an object in the received image on the basis of machine-learned artificial intelligence (AI) on the basis of a previously stored object model.

Here, the bounding box is an area for specifying an object corresponding to a facility among the objects included in the image. That is, the bounding box may specify each median barrier including a pair of vertical bars and horizontal bars connecting the vertical bars. The bounding box like this may have a rectangular or polygonal shape, and it is not limited thereto.

Meanwhile, as the median barrier located at the bottom left in the region of interest is not fully contained in the camera angle, it is captured as an image of a partially truncated form.

Accordingly, when a plurality of bounding boxes is specified in the region of interest, the facility management unit 320 may detect a bounding box closest in distance to a specific point, and exclude the detected bounding box. Here, the feature point may be the bottom left in the region of interest as described above.

Meanwhile, although the median barrier is located at the bottom left in the region of interest, the median barrier photographed at a time point when the median barrier ends may be contained in the camera angle entirely. Accordingly, the facility management unit 320 may exclude the detected bounding box, i.e., exclude a bounding box detected when the bounding box is successively detected as many times as a preset number at the position of a bounding box detected first in the images successively received from the camera. That is, when the median barrier is not detected at a corresponding position after the median barrier is detected first at the bottom left in the images sorted in order of time, it may be determined as a time point when the median barrier ends, and when the median barrier is successively detected at the corresponding position, it is determined that the median barrier is not fully contained in the camera angle, and the median barrier may be excluded.

However, it is not limited thereto, and when a plurality of bounding boxes is specified in the region of interest, the facility management unit 320 may detect a bounding box located within a rectangle of a preset size including a specific point as the bottom left vertex, and exclude the detected bounding box. That is, the facility management unit 320 may determine all median barriers existing in a specific area inside the region of interest as median barriers that are not contained in the camera angle and exclude them all.

Next, the facility management unit 320 may process the image to accurately determine whether the identified object is damaged.

Specifically, the facility management unit 320 may replace the value of all pixels existing inside the bounding box with a local minimum in order to approach the image from a morphological perspective. That is, the facility management unit 320 may replace neighboring pixels with a minimum pixel value by utilizing structural elements. Through this, the facility management unit 320 may decrease the bright area and increase the dark area in the image, and speckles disappear as the dark area increases according to the size of the kernel or the number of repetitions, and noise can be removed by increasing the holes inside an object corresponding to the median barrier.

Meanwhile, in the image, pixels in the (x, y) coordinate space appear in the form of a curve in the (r, θ) parameter space. In addition, pixels existing on the same straight line in the (x, y) coordinate space have intersection points in the (r, θ) parameter space.

Accordingly, the facility management unit 320 may derive the intersection points after mapping the pixels existing in the bounding box from the (x, y) coordinate space to the (r, θ) parameter space, and extract an edge corresponding to the component of the straight line on the basis of pixels corresponding to the derived intersection points. That is, the facility management unit 320 may detect at least one horizontal bar from the median barrier existing in the bounding box.

In addition, the facility management unit 320 may determine whether the object corresponding to the processed image is damaged.

Specifically, the facility management unit 320 may generate a plurality of straight lines parallel to each other and formed in the height direction of the bounding box at preset intervals inside the bounding box, and determine whether the image is damaged on the basis of the number of contact points between the extracted edge and the plurality of generated straight lines. That is, the facility management unit 320 may generate a plurality of virtual lines parallel to the y-axis of the image and spaced apart from each other by a predetermined distance, and determine whether each horizontal bar is damaged on the basis of the number of contact points in contact with each virtual line of each horizontal bar.

For example, two contact points are detected per virtual line in a normal horizontal bar. On the other hand, a damaged horizontal bar may have no contact points.

Accordingly, the facility management unit 320 may identify the number of horizontal bars included in the median barrier on the basis of the number of contact points between the extracted edge and the plurality of generated straight lines, and determine that the median barrier is damaged when the number of horizontal bars is smaller than a preset value.

In addition, when it is determined that the median barrier is damaged, the facility management unit 320 may change the color of a pixel corresponding to the damaged object on the previously stored map to a preset color. For example, when the previously stored map is a map configured of point cloud data acquired by the LiDAR, the facility management unit 320 may support to display a point cloud corresponding to the damaged object in red so that the manager may intuitively confirm damage of the facility.

In addition, the facility management unit 320 may detect a facility in the image captured by the camera mounted on the vehicle traveling on the road, and identify the type of the facility by recognizing text written on the detected facility.

To this end, the facility management unit 320 may identify an object corresponding to a preset facility on the image captured by the camera.

Specifically, the facility management unit 320 may perform segmentation on the image and specify at least one bounding box corresponding to the object. That is, the facility management unit 320 may specify at least one bounding box corresponding to the object in the image on the basis of machine-learned artificial intelligence (AI) on the basis of the facility image.

Next, the facility management unit 320 may recognize text included in the identified object. For example, the facility management unit 320 may recognize text through optical character recognition (OCR).

Meanwhile, when encoding is performed in the process of recognizing Korean characters, although the words are the same, there is a format of displaying consonants and vowels of a Korean character string together and a format of separating the consonants and vowels.

For example, when two identical sentences ‘Reduce speed’ are encoded as shown in the code below, there may be a case where the length of each string is different.

```
  Str1 = ‘Reduce speed’
  str2 = ‘Reduce speed’
  >>> print(temp_str1.encode(‘utf-8’))
  >>> print(temp_str2.encode(‘utf-8’))
  b‘\xec\xa0\x84\xea\xb5\xad\xeb\xb3\xb4\xed\x96\x89\xec\x9e\x90\xec\xa0\x84\x
ec\x9a\xa9\xeb\x8f\x84\xeb\xa1\x9c\xed\x91\x9c\xec\xa4\x80\xeb\x8d\xb0\xec\x9d\xb4\xed\x84
\xb0’
  b‘\xe1\x84\x8c\xe1\x85\xa5\xe1\x86\xab\xe1\x84\x80\xe1\x85\xae\xe1\x86\xa8\
xe1\x84\x87\xe1\x85\xa9\xe1\x84\x92\xe1\x85\xa2\xe1\x86\xbc\xe1\x84\x8c\xe1\x85\xa1\xe1\x
84\x8c\xe1\x85\xa5\xe1\x86\xab\xe1’
```

Accordingly, the facility management unit 320 may normalize the Unicode corresponding to the recognized text using an NFC method to solve the phenomenon that the consonants and vowels in a Korean character string are separated and non-comparable. In addition, text may be recognized by comparing the normalized Unicode with a previously stored Unicode that is normalized using the NFC method.

Meanwhile, in a general optical character recognition model, a problem of low precision may occur according to the state of text included in an actual image. Accordingly, the facility management unit 320 may determine similarity of the text with a previously stored correct answer string on the basis of a character error rate (CER), which represents the character error rate between a string identified through optical character recognition and the correct answer string. Here, the facility management unit 320 may calculate the character error rate on the basis of the number of insertions, deletions, and changes minimally required for the character string recognized through optical character recognition to be the equal to the previously stored correct answer string.

For example, the facility management unit 320 may calculate the character error rate using the following equation.

$$CER = \frac{S + D + I}{N} \qquad [ Equation ]$$

(Here, S denotes the number of uniliteral characters or words having a substitution or misspelling error, D denotes the number of uniliteral characters and words having a deletion or missing error, and I denotes the number of times of having an insertion error or including incorrect uniliteral characters/words)

The facility management unit 320 may recognize text on the basis of a string with a minimum character error rate among the previously stored correct answer strings.

In addition, the facility management unit 320 may identify the type of a facility corresponding to the identified object on the basis of the recognized text. That is, the facility management unit 320 may identify the type of a facility by comparing the recognized text with a previously stored facility list.

Meanwhile, the facility management unit 320 may record and manage the type of the identified facility on a previously stored map. In addition, when the identified facility does not exist in the existing map and is an added facility, the facility management unit 320 may update the existing map on the basis of the captured image.

At this point, the facility management unit 320 may replace an image model corresponding to the type of the identified facility with the identified object. That is, in order to update the facility more clearly on the existing map, the facility management unit 320 may delete the image area corresponding to the identified object and insert a facility model corresponding to the facility in the deleted area as a replacement.

At this point, the facility management unit 320 may replace the image model with the object identified in the image in a way of estimating the angle of the identified object on the basis of the shape of the identified object, and applying the estimated angle to the image model. Here, the facility management unit 320 may extract the edge of the identified object on the basis of the RGB value inside a bounding box corresponding to the identified object, and estimate the shape of the object through the extracted edge.

As a next configuration, the noise removal unit 325 may remove noise according to dynamic objects in the process of acquiring data to create a map.

To this end, the noise removal unit 325 may receive point cloud data acquired by the LiDAR and an image captured by the camera. At this point, the noise removal unit 325 may compress the received image to reduce the volume of a result of segmentation for identifying an object. That is, the noise removal unit 325 may grasp whether data of the image in the past through a dictionary-type compression algorithm, indicate whether the image is repeated, and encode the image in a way of compressing the image by assigning a different prefix code according to the frequency of appearance of characters included in the image. Through this, the noise removal unit 325 may reduce the volume of the image in a speedy way and maintain the quality.

Next, the noise removal unit 325 may identify a preset object from the image.

Specifically, the noise removal unit 325 may identify a preset object from the image through segmentation on the basis of machine-learned artificial intelligence (AI).

For example, the noise removal unit 325 may specify a bounding box in an area corresponding to the preset object in the image. Here, the bounding box is an area for specifying an object corresponding to noise among the objects included in the image. The bounding box like this may have a rectangular or polygonal shape, and it is not limited thereto.

However, it is not limited thereto, and the noise removal unit 325 may identify an object by performing semantic segmentation on the image on the basis of machine-learned artificial intelligence on the basis of data corresponding to the object.

In addition, the noise removal unit 325 may record time stamps for images successively received from the camera, sort the successively received images on the basis of the recorded time stamps, and identify an object on the basis of the similarity between neighboring images among the sorted images.

That is, the object of the noise removal unit 325 is to recognize dynamic objects as noise and delete the dynamic objects from the image. Accordingly, the noise removal unit 325 may identify an object of which the similarity with a successive image is higher than a preset value as a dynamic object. At this point, the noise removal unit 325 may identify an object moving inside the image on the basis of change in RGB (Red, Green, Blue) between neighboring images.

Next, the noise removal unit 325 may delete the point cloud corresponding to the object identified from the image from the point cloud data.

Specifically, the noise removal unit 325 may perform calibration on the image and point cloud data, and delete a point cloud at the same coordinates as the object identified from the image.

At this point, the noise removal unit 325 may group the point cloud included in the object identified from the image into a plurality of unit point clouds on the basis of the value of distance from the LiDAR, and identify and delete a unit point cloud with a smallest value of distance from the LiDAR among the plurality of unit point clouds as a point cloud corresponding to the object. That is, as the point cloud data is acquired by the LiDAR mounted on the vehicle, the noise removal unit 325 may identify a point cloud with a relatively small value of distance from the LiDAR as a vehicle, which is one of dynamic objects, and delete the point cloud.

In addition, the noise removal unit 325 may identify outliers among the point clouds included in the object identified from the image on the basis of density and delete point clouds excluding the identified outliers. That is, among the point clouds included in the object identified from the image, there may be point clouds of objects other than the dynamic objects corresponding to noise. Accordingly, the noise removal unit 325 may identify a point cloud included in an object other than the object identified on the basis of density as an outlier and delete the point cloud excluding the identified object.

In addition, the noise removal unit 325 may identify at least one object on the basis of density from the point cloud data acquired by the LiDAR, and additionally delete point clouds included in an object of which the change in the distance exceeds a preset value among the at least one identified object.

Meanwhile, in the above description, the noise removal unit 325 creates a map on the basis of the point cloud data from which point clouds corresponding to the object identified from the image are deleted. However, the present invention is not limited thereto, and the noise removal unit 325 may delete point clouds corresponding to an object identified on a map previously created on the basis of the point cloud data acquired by the LiDAR and the image captured by the camera. That is, the noise removal unit 325 may delete objects identified on a previously stored map.

As a next configuration, the model lightweight unit 330 may lighten the artificial intelligence model to increase inference speed while maintaining, as much as possible, accuracy of the artificial intelligence model for detecting objects on an image captured by the camera. Here, the artificial intelligence model may be an artificial intelligence model for detecting objects on an image captured by the camera.

To this end, the model lightweight unit 330 may perform pruning on the artificial intelligence model machine-learned using a first data set.

Specifically, the model lightweight unit 330 may convert a corresponding weight to ‘0’ when the weight value of each layer included in the artificial intelligence model is smaller than or equal to a preset value. That is, the model lightweight unit 330 may reduce the number of parameters of the artificial intelligence model by removing connection of weights of low importance among the weights of the artificial intelligence model.

At this point, the model lightweight unit 330 may analyze sensitivity of the artificial intelligence model. Here, the sensitivity parameter may be a parameter that determines which weight or layer is most greatly affected by pruning. In order to calculate the sensitivity parameter of the artificial intelligence model, the model lightweight unit 330 may derive the sensitivity parameter by performing iterative pruning by applying a threshold preset for the weight to the artificial intelligence model.

The model lightweight unit 330 may determine a threshold for a weight value by multiplying the sensitivity parameter according to analyzed sensitivity by the standard deviation of the weight value distribution of the artificial intelligence model.

For example, the threshold for the weight value may be set as shown in the following equation.

$$thresh ( {w}_{i} ) = \{ \begin{matrix}{w}_{i} : if \vert {w}_{i} \vert > λ \\ 0 : if \vert {w}_{i} \vert \leq λ\end{matrix} \} \qquad [ Equation ]$$

(Here, λ may be s*σl, σl may be the standard of layer l measured in a denso model, and s may be a sensitivity parameter.)

That is, the model lightweight unit 330 may utilize that weight distribution of the convolution layer and the fully connected layer of the artificial intelligence model has a Gaussian distribution.

Thereafter, the model lightweight unit 330 may quantize the pruned artificial intelligence model.

Specifically, the model lightweight unit 330 may convert an artificial intelligence model configured as a “floating point 32-bit type” into a “signed 8-bit integer type.” However, it is not limited thereto, and the model lightweight unit 330 may convert the weight of the artificial intelligence model and the input between layers into a value of binary form according to the sign.

That is, the model lightweight unit 330 may calculate a minimum value and a maximum value among the decimal values (floating point 32-bit) of each layer. In addition, the model lightweight unit 330 may linearly map corresponding decimal values to a nearest integer value (signed 8-bit integer). For example, when the decimal value range of an existing layer is −3.0 to 6.0, the model lightweight unit 330 may map −3.0 to −127 and 6.0 to +127.

At this point, the model lightweight unit 330 may quantize a plurality of weights of the artificial intelligence model, and quantize activation at the time point of inference.

In another embodiment, the model lightweight unit 330 may quantize a plurality of weights of the artificial intelligence model, and may previously quantize the plurality of weights and activations of the artificial intelligence model.

In still another embodiment, the model lightweight unit 330 may determine the weight and perform quantization at the same time by simulating in advance the effect of applying quantization during inference at the time point when learning of the artificial intelligence model is progressed.

In addition, the model lightweight unit 330 may learn the artificial intelligence model by imitating another artificial intelligence model previously trained using a second data set containing a larger amount of data than the first data set.

Specifically, the model lightweight unit 330 may calculate a loss by comparing outputs of the artificial intelligence model and another artificial intelligence model, and learn the artificial intelligence model so that the calculated loss can be minimized.

That is, the model lightweight unit 330 may learn by imitating another artificial intelligence model on the basis of a loss function according to the equation shown below.

$$TotalLoss = ( 1 - α ) {L}_{CE} ( σ ( {Z}_{s} ) , \hat{y} ) + 2 α {T}^{e} {L}_{CE} ( σ ( \frac{{Z}_{s}}{T} ) , σ ( \frac{{Z}_{s}}{T} ) ) \qquad [ Equation ]$$

(Here, L_{CE} denotes a cross entropy loss, σ denotes Softmax, Zₛ denotes output logits of the artificial intelligence model, Zₜ denotes output logits of another artificial intelligence model, ŷ denotes the ground truth (one-hot), α denotes a balancing parameter, and T denotes a temperature hyperparameter.)

In other words, as the loss of classification performance of the artificial intelligence, the model lightweight unit 330 may calculate the difference between the ground truth and the output logits of the artificial intelligence model as the cross entropy loss.

In addition, the model lightweight unit 330 may include the difference in the result of classifying another artificial intelligence model and the artificial intelligence model in the loss. In addition, the model lightweight unit 330 may calculate the difference of a value converting the output logits of another artificial intelligence model and the artificial intelligence model using Softmax as a cross entropy loss. At this point, the model lightweight unit 330 may take a small value when the results of classifying another artificial intelligence model and the artificial intelligence model are the same.

Meanwhile, a may be a parameter for the weights of the left and right terms. T may be a parameter alleviating the property of the Softmax function that makes a large input value very large and a small input value very small.

That is, the model lightweight unit 330 may improve performance of the model, although it has relatively few parameters, by training to imitate an artificial intelligence model, which is a lightweight target of a relatively small model, through the output of previously trained another artificial intelligence model.

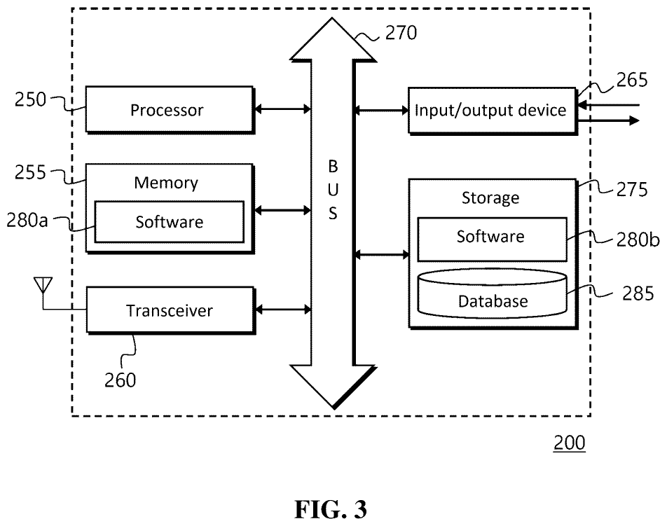

FIG. 3 is a view showing the hardware configuration of a data processing device according to an embodiment of the present invention.

Referring to FIG. 3, the data processing device 300 may be configured to include a processor 350, a memory 355, a transceiver 360, an input/output device 365, a data bus 370, and a storage 375.

The processor 350 may implement operations and functions of the data processing device 300 on the basis of instructions according to the software 380a loaded on the memory 355. The software 380a implementing the method according to an embodiment of the present invention may be loaded on the memory 355. The transceiver 360 may transmit and receive data to and from the data collection device 100 and data generation device 200.

The input/output device 365 may receive data needed for the operation of the data processing device 300 and output a generated result value. The data bus 370 is connected to the processor 350, the memory 355, the transceiver 360, the input/output device 365, and the storage 375 to perform a function of a moving path for transferring data between the components.

The storage 375 may store application programming interfaces (API), library files, resource files, and the like needed for execution of the software 380a in which the method according to the present invention is implemented. The storage 375 may store software 380b in which the method according to the present invention is implemented. In addition, the storage 375 may store information needed for performing the method according to the present invention. Particularly, the storage 375 may include a database 385 for storing programs for performing the method.

According to an embodiment of the present invention, the software 380a and 380b loaded on the memory 355 or stored in the storage 375 may be a computer program recorded on a recording medium to execute the steps of: receiving point cloud data acquired by a LiDAR installed on a vehicle traveling on a route on a previously stored reference map and an image captured through a camera, by the processor 350; identifying an object on the basis of the received point cloud data and image, by the processor 350; and updating facility information on the reference map by matching the identified object with the reference map, by the processor 350.

According to another embodiment of the present invention, the software 380a and 380b loaded on the memory 355 or stored in the storage 375 may be a computer program recorded on a recording medium to execute the steps of: receiving point cloud data acquired by a LiDAR and an image captured by a camera, by the processor 350; identifying a preset object from the image, by the processor 350; and deleting a point cloud corresponding to the object identified from the image from the point cloud data, by the processor 350; and creating a map on the basis of the point cloud data from which the point cloud corresponding to the object is deleted, by the processor 350.

According to another embodiment of the present invention, the software 380a and 380b loaded on the memory 355 or stored in the storage 375 may be a computer program recorded on a recording medium to execute the steps of: identifying an object corresponding to a preset facility in an image captured by a camera, by the processor 350; processing an image of the identified object, by the processor 350; and determining whether the object corresponding to the processed image is damaged, by the processor 350.

According to another embodiment of the present invention, the software 380a and 380b loaded on the memory 355 or stored in the storage 375 may be a computer program recorded on a recording medium to execute the steps of: performing pruning on an artificial intelligence model machine-learned using a first data set, by the processor 350; quantizing the pruned artificial intelligence model, by the processor 350; and learning the artificial intelligence model by imitating another artificial intelligence model previously trained using a second data set containing a larger amount of data than the first data set, by the processor 350.

According to still another embodiment of the present invention, the software 380a and 380b loaded on the memory 355 or stored in the storage 375 may be a computer program recorded on a recording medium to execute the steps of: identifying an object corresponding to a preset facility in an image captured by a camera, by the processor 350; recognizing text included in the identified object, by the processor 350; and identifying the type of a facility corresponding to the identified object on the basis of the recognized text, by the processor 350.

More specifically, the processor 350 may include an Application-Specific Integrated Circuit (ASIC), another chipset, a logic circuit, and/or a data processing device. The memory 355 may include read-only memory (ROM), random access memory (RAM), flash memory, a memory card, a storage medium, and/or other storage devices. The transceiver 360 may include a baseband circuit for processing wired/wireless signals. The input/output device 365 may include an input device such as a keyboard, a mouse, and/or a joystick, an image output device such as a Liquid Crystal Display (LCD), an Organic LED (OLED), and/or an active matrix OLED (AMOLED), and a printing device such as a printer, a plotter, or the like.

When the embodiments included in this specification are implemented as software, the method described above may be implemented as a module (process, function, or the like) that performs the functions described above. The module may be loaded on the memory 355 and executed by the processor 350. The memory 355 may be inside or outside the processor 350 and connected to the processor 350 by various well-known means.

Each component shown in FIG. 3 may be implemented by various means, for example, hardware, firmware, software, or a combination thereof. When a component is implemented as hardware, an embodiment of the present invention may be implemented as one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, and the like.

In addition, when the component is implemented as firmware or software, an embodiment of the present invention may be implemented in the form of a module, procedure, function, or the like that performs the functions or operations described above, and recorded on a recording medium that can be read through various computer means. Here, the recording medium may include program commands, data files, data structures, and the like individually or in combination. Program instructions recorded on a recording medium may be instructions specially designed and configured for the present invention or those known to and used by those skilled in computer software. For example, the recording medium includes magnetic media such as hard disks, floppy disks, and magnetic tapes, optical media such as Compact Disk Read Only Memory (CD-ROMs) and Digital Video Disks (DVDs), magneto-optical media such as floptical disks, and hardware devices specially configured to store and execute program instructions, such as ROM, RAM, flash memory, and the like. Examples of the program instructions may include high-level language codes that can be executed by a computer using an interpreter or the like, as well as machine language codes generated by a compiler. These hardware devices may be configured to operate as one or more pieces of software to perform the operations of the present invention, and vice versa.

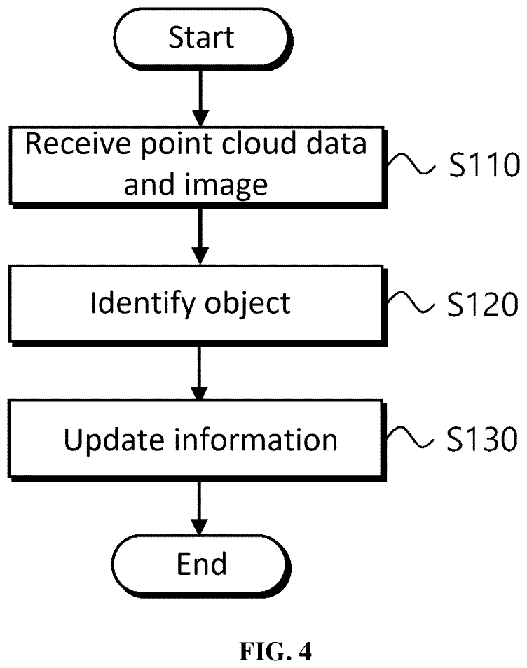

FIG. 4 is a flowchart illustrating a facility update method according to an embodiment of the present invention.

Referring to FIG. 4, first, at step S110, the data processing device may receive point cloud data acquired by a LiDAR installed on a vehicle traveling on a route on a previously stored reference map and an image captured through a camera.

Next, at step S120, the data processing device may identify an object corresponding to a facility on the basis of the received point cloud data and image.

Specifically, the data processing device may set a bounding box for an area corresponding to an object in the received image. At this point, the data processing device may set a bounding box for an area corresponding to an object in the received image on the basis of machine-learned artificial intelligence (AI) on the basis of a previously stored object model.

In addition, the data processing device may collect point clouds included in the bounding box by projecting the point cloud data onto the image. That is, the data processing device may collect the points included in the bounding box by projecting the point cloud data acquired by the LiDAR through calibration of the camera and the LiDAR onto the image. At this point, the data processing device may accumulate and store the points included in the bounding box for a plurality of images received successively.

In addition, the data processing device may classify and cluster the collected point clouds in units of objects. That is, the data processing device may cluster the collected point clouds in units of objects on the basis of point attributes including one among GPS coordinates, density, and class name.

Meanwhile, in performing the clustering, the data processing device may generate at least one first cluster instance by applying a Euclidean clustering algorithm to the collected point clouds. That is, the data processing device may perform clustering on the basis of a Euclidean distance according to the equation shown below.

$$d ( x , y ) = \sqrt{{( {x}_{1} - {y}_{1} )}^{2} + ⋯ + {( {x}_{p} - {y}_{p} )}^{2}} \qquad [ Equation ]$$

(Here, x and y include arbitrary two points included inside the bounding box.)

At this point, the data processing device may identify the at least one generated first cluster instance as an object.

It is not limited thereto, and the data processing device may generate at least one second cluster instance on the basis of class names of the points included in the at least one generated first cluster instance, and identify the newly generated second cluster instance as an object. That is, the data processing device may calculate a score value of at least one first cluster instance for each class name, and when the calculated score value is greater than or equal to a preset value, it may be regarded as at least one second cluster instance.

The data processing device may generate at least one third cluster instance for each of the second cluster instances by applying the Euclidean clustering algorithm.

In addition, the data processing device may identify the at least one generated third cluster instance as an object. That is, the data processing device may set a representative point representing each of the third cluster instances, extract coordinates corresponding to the representative point, and identify the coordinates of the object.

In addition, at step S130, the data processing device may update information on the objects on the reference map by matching the identified object with the reference map.

Specifically, the data processing device may update information on an object on the reference map by matching the identified object with the object on the reference map, and may give a status value according to new, delete, move, and change to the object on the updated reference map.

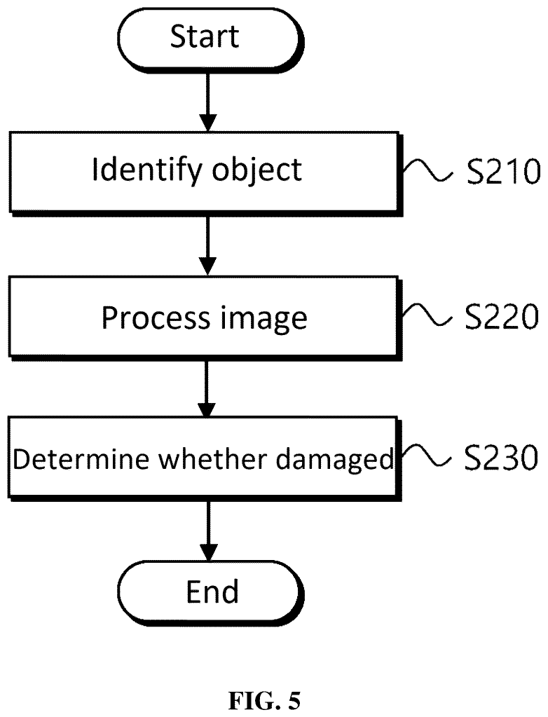

FIG. 5 is a flowchart illustrating a facility management method according to an embodiment of the present invention.

Referring to FIG. 5, first, at step S210, the data processing device may identify an object corresponding to a preset facility on an image captured by the camera.

Here, the facility may be a median barrier installed on the road. The median barrier may be configured of vertical bars spaced apart from each other at regular intervals along the center line and horizontal bars connecting a pair of adjacent vertical bars.

Specifically, the data processing device may set a region of interest (ROI) inside the image. At this point, the data processing device may set a rectangle of a preset size, including a specific point located at the bottom left of the image as the bottom left vertex, as a region of interest. That is, the camera acquires an image of the front side of the vehicle driving on the road. Accordingly, due to the characteristics of domestic roads, the median barrier is located at the bottom left of the image. Accordingly, the data processing device may reduce the amount of calculation according to specifying a bounding box by specifying the bottom left of the image as a region of interest since the entire image is not considered.

Thereafter, the data processing device may perform segmentation inside the set region of interest and specify at least one bounding box corresponding to an object. That is, the data processing device may set a bounding box for an area corresponding to an object in the received image on the basis of machine-learned artificial intelligence (AI) on the basis of a previously stored object model.

At this point, when a plurality of bounding boxes is specified in the region of interest, the data processing device may detect a bounding box closest in distance to a specific point, and exclude the detected bounding box. Here, the feature point may be the bottom left in the region of interest as described above.

Meanwhile, although the median barrier is located at the bottom left in the region of interest, the median barrier photographed at a time point when the median barrier ends may be contained in the camera angle entirely. Accordingly, the data processing device may exclude the detected bounding box, i.e., may exclude a bounding box detected when the bounding box is successively detected as many times as a preset number at the position of a bounding box detected first in the images successively received from the camera. That is, when the median barrier is not detected at the corresponding position after the median barrier is detected first at the bottom left in the images sorted in order of time, it may be determined as the time point where the median barrier ends, and when the median barrier is successively detected at the corresponding position, it is determined that the median barrier is not fully contained in the camera angle, and the median barrier may be excluded.

However, it is not limited thereto, and when a plurality of bounding boxes is specified in the region of interest, the data processing device may detect a bounding box located within a rectangle of a preset size including a specific point as the bottom left, and exclude the detected bounding box. That is, the data processing device may determine all median barriers existing in a specific area inside the region of interest as median barriers that are not contained in the camera angle and exclude them all.

Next, at step S220, the data processing device may process the image to accurately determine whether the identified object is damaged.

Specifically, the data processing device may replace the value of all pixels existing inside the bounding box with a local minimum in order to approach the image from a morphological perspective. That is, the data processing device may replace neighboring pixels with a minimum pixel value by utilizing structural elements. Through this, the facility management unit 320 may decrease the bright area and increase the dark area in the image, and speckles disappear as the dark area increases according to the size of the kernel or the number of repetitions, and noise can be removed by increasing the holes inside an object corresponding to the median barrier.

Meanwhile, in the image, pixels in the (x, y) coordinate space appear in the form of a curve in the (r, \grave{θ}) parameter space. In addition, pixels existing on the same straight line in the (x, y) coordinate space have intersection points in the (r, \grave{θ}) parameter space.

Accordingly, the data processing device may derive the intersection points after mapping the pixels existing in the bounding box from the (x, y) coordinate space to the (r, θ) parameter space, and extract an edge corresponding to the component of the straight line on the basis of pixels corresponding to the derived intersection points. That is, the data processing device may detect at least one horizontal bar from the median barrier existing in the bounding box.

In addition, at step S230, the data processing device may determine whether the object corresponding to the processed image is damaged.

Specifically, the data processing device may generate a plurality of straight lines parallel to each other and formed in the height direction of the bounding box at preset intervals inside the bounding box, and determine whether the image is damaged on the basis of the number of contact points between the extracted edge and the plurality of generated straight lines. That is, the data processing device may generate a plurality of virtual lines parallel to the y-axis of the image and spaced apart from each other by a predetermined distance, and determine whether each horizontal bar is damaged on the basis of the number of contact points in contact with each virtual line of each horizontal bar.

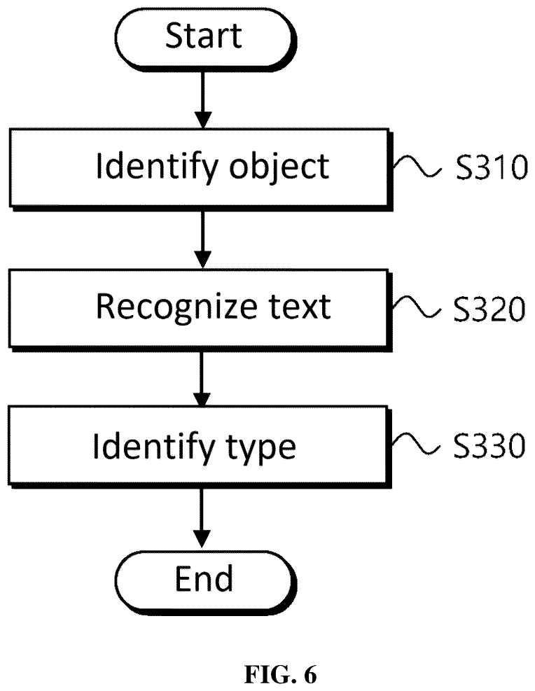

FIG. 6 is a flowchart illustrating a facility management method according to another embodiment of the present invention.

Referring to FIG. 6, first, at step S310, the data processing device may identify an object corresponding to a preset facility on an image captured by the camera.

Specifically, the data processing device may perform segmentation on the image and specify at least one bounding box corresponding to the object. That is, the data processing device may specify at least one bounding box corresponding to the object in the image on the basis of machine-learned artificial intelligence (AI) on the basis of the facility image.

Next, at step S320, the data processing device may recognize text included in the identified object.

Accordingly, the data processing device may normalize the Unicode corresponding to the recognized text using an NFC method to solve the phenomenon that the consonants and vowels in a Korean character string are separated and non-comparable. In addition, text may be recognized by comparing the normalized Unicode with a previously stored Unicode that is normalized using the NFC method.

In addition, the data processing device may determine similarity of the text with a previously stored correct answer string on the basis of a character error rate (CER), which represents the character error rate between a string identified through optical character recognition and the correct answer string. Here, the data processing device may calculate the character error rate on the basis of the number of insertions, deletions, and changes minimally required for the character string recognized through optical character recognition to be the equal to the previously stored correct answer string.

The data processing device may calculate the character error rate using the following equation.

$$CER = \frac{S + D + I}{N} \qquad [ Equation ]$$

(Here, S denotes the number of uniliteral characters or words having a substitution or misspelling error, D denotes the number of uniliteral characters and words having a deletion or missing error, and I denotes the number of times of having an insertion error or including incorrect uniliteral characters/words)

The data processing device may recognize text on the basis of a string with a minimum character error rate among the previously stored correct answer strings.

In addition, at step S330, the data processing device may identify the type of a facility corresponding to the identified object on the basis of the recognized text. That is, the data processing device may identify the type of a facility by comparing the recognized text with a previously stored facility list.

Meanwhile, the data processing device may record and manage the type of the identified facility on a previously stored map. In addition, when the identified facility does not exist in the existing map and is an added facility, the data processing device may update the existing map on the basis of the captured image.

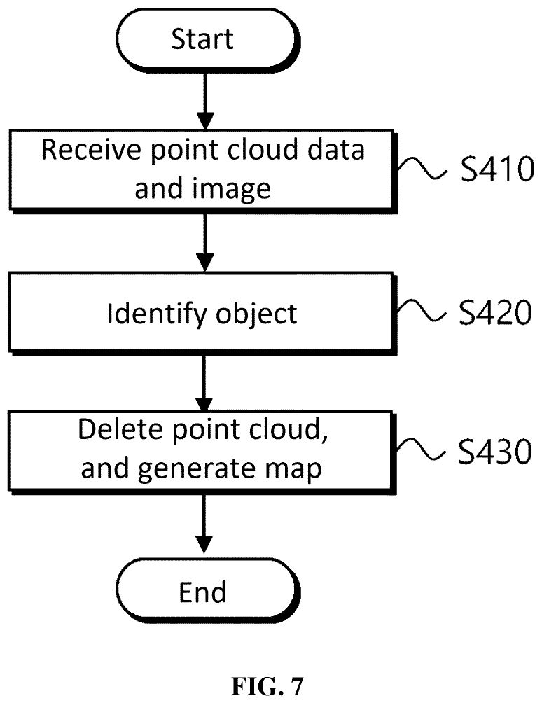

FIG. 7 is a flowchart illustrating a noise removing method according to an embodiment of the present invention.

Referring to FIG. 7, at step S410, the data processing device may receive point cloud data acquired by the LiDAR and an image captured by the camera.

At this point, the data processing device may compress the received image to reduce the volume of a result of segmentation for identifying an object. That is, the data processing device may grasp whether data of the image in the past through a dictionary-type compression algorithm, indicate whether the image is repeated, and encode the image in a way of compressing the image by assigning a different prefix code according to the frequency of appearance of characters included in the image.

Next, at step S420, the data processing device may identify a preset object from the image.

Specifically, the data processing device may identify a preset object from the image through segmentation on the basis of machine-learned artificial intelligence (AI).

That is, the data processing device may specify a bounding box in an area corresponding to the preset object in the image. However, it is not limited thereto, and the data processing device may identify an object by performing semantic segmentation on the image on the basis of machine-learned artificial intelligence on the basis of data corresponding to the object.

In addition, the data processing device may record time stamps for images successively received from the camera, sort the successively received images on the basis of the recorded time stamps, and identify an object on the basis of the similarity between neighboring images among the sorted images.

That is, the object of the data processing device is to recognize dynamic objects as noise and delete the dynamic objects from the image. Accordingly, the data processing device may identify an object of which the similarity with a successive image is higher than a preset value as a dynamic object. At this point, the data processing device may identify an object moving inside the image on the basis of change in RGB (Red, Green, Blue) between neighboring images.

In addition, at step S430, the data processing device may delete a point cloud corresponding to the object identified from the image from the point cloud data.

Specifically, the data processing device may perform calibration on the image and point cloud data, and delete a point cloud at the same coordinates as the object identified from the image.

At this point, the data processing device may group the point cloud included in the object identified from the image into a plurality of unit point clouds on the basis of the value of distance from the LiDAR, and identify and delete a unit point cloud with a smallest value of distance from the LiDAR among the plurality of unit point clouds as a point cloud corresponding to the object. That is, as the point cloud data is acquired by the LiDAR mounted on the vehicle, the data processing device may identify a point cloud with a relatively small value of distance from the LiDAR as a vehicle, which is one of dynamic objects, and delete the point cloud.

In addition, the data processing device may identify outliers among the point clouds included in the object identified from the image on the basis of density and delete point clouds excluding the identified outliers. That is, among the point clouds included in the object identified from the image, there may be point clouds of objects other than the dynamic objects corresponding to noise. Accordingly, the data processing device may identify a point cloud included in an object other than the object identified on the basis of density as an outlier and delete the point cloud excluding the identified object.

In addition, the data processing device may identify at least one object on the basis of density from the point cloud data acquired by the LiDAR, and additionally delete point clouds included in an object of which the change in the distance exceeds a preset value among the at least one identified object.

In addition, the data processing device may create a map on the basis of the point cloud data from which point clouds corresponding to the object identified from the image are deleted.

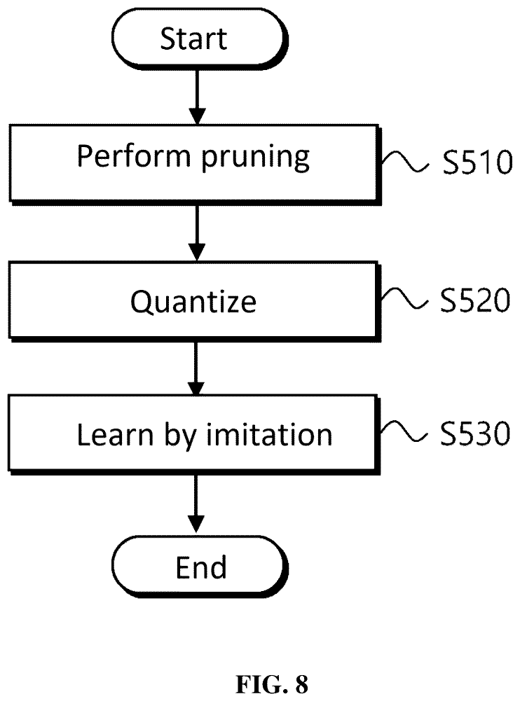

FIG. 8 is a flowchart illustrating a method of lightweighting an artificial intelligence model according to an embodiment of the present invention.

Referring to FIG. 8, first, at step S510, the data processing device may perform pruning on the artificial intelligence model machine-learned using a first data set.

Specifically, the data processing device may convert a corresponding weight to ‘0’ when the weight value of each layer included in the artificial intelligence model is smaller than or equal to a preset value. That is, the data processing device may reduce the parameters of the artificial intelligence model by removing connection of weights of low importance among the weights of the artificial intelligence model.

At this point, the data processing device may analyze sensitivity of the artificial intelligence model. Here, the sensitivity parameter may be a parameter that determines which weight or layer is most greatly affected by pruning. In order to calculate the sensitivity parameter of the artificial intelligence model, the data processing device may derive the sensitivity parameter by performing iterative pruning by applying a threshold preset for the weight to the artificial intelligence model.

The data processing device may determine a threshold for a weight value by multiplying the sensitivity parameter according to analyzed sensitivity by the standard deviation of the weight value distribution of the artificial intelligence model.

For example, the threshold for the weight value may be set as shown in the following equation.

$$thresh ( {w}_{i} ) = \{ \begin{matrix}{w}_{i} : if \vert {w}_{i} \vert > λ \\ 0 : if \vert {w}_{i} \vert \leq λ\end{matrix} \} \qquad [ Equation ]$$

(Here, λ may be s*σl, σl may be the standard of layer l measured in a denso model, and s may be a sensitivity parameter.)

That is, the data processing device may utilize that weight distribution of the convolution layer and the fully connected layer of the artificial intelligence model has a Gaussian distribution.

Next, the data processing device may quantize the pruned artificial intelligence model.

Specifically, the data processing device may convert an artificial intelligence model configured as a “floating point 32-bit type” into a “signed 8-bit integer type”. However, it is not limited thereto, and the data processing device may convert the weight of the artificial intelligence model and the input between layers into a value of binary form according to the sign.

That is, the data processing device may calculate a minimum value and a maximum value among the decimal values (floating point 32-bit) of each layer. In addition, the data processing device may linearly map corresponding decimal values to a nearest integer value (signed 8-bit integer).

At this point, the data processing device may quantize a plurality of weights of the artificial intelligence model, and quantize activation at the time point of inference.

In another embodiment, the data processing device may quantize a plurality of weights of the artificial intelligence model, and may previously quantize the plurality of weights and activations of the artificial intelligence model.

In still another embodiment, the data processing device may determine the weight and perform quantization at the same time by simulating in advance the effect of applying quantization during inference at the time point when learning of the artificial intelligence model is progressed.

In addition, at step S530, the data processing device may learn the artificial intelligence model by imitating another artificial intelligence model previously trained using a second data set containing a larger amount of data than the first data set.

Specifically, the data processing device may calculate a loss by comparing outputs of the artificial intelligence model and another artificial intelligence model, and learn the artificial intelligence model so that the calculated loss can be minimized.

That is, the data processing device may learn by imitating another artificial intelligence model on the basis of a loss function according to the equation shown below.

$$TotalLoss = ( 1 - α ) {L}_{CE} ( σ ( {Z}_{s} ) , \hat{y} ) + 2 α {T}^{e} {L}_{CE} ( σ ( \frac{{Z}_{s}}{T} ) , σ ( \frac{{Z}_{s}}{T} ) ) \qquad [ Equation ]$$

(Here, L_{CE} denotes a cross entropy loss, σ denotes Softmax, Zₛ denotes output logits of the artificial intelligence model, Zₜ denotes output logits of another artificial intelligence model, ŷ denotes the ground truth (one-hot), α denotes a balancing parameter, and T denotes a temperature hyperparameter.)

In other words, as the loss of classification performance of the artificial intelligence, the data processing device may calculate the difference between the ground truth and the output logits of the artificial intelligence model as the cross entropy loss.

In addition, the data processing device may include the difference in the result of classifying another artificial intelligence model and the artificial intelligence model in the loss. In addition, the model lightweight unit 330 may calculate the difference of a value converting the output logits of another artificial intelligence model and the artificial intelligence model using Softmax as a cross entropy loss. At this point, the data processing device may take a small value when the results of classifying another artificial intelligence model and the artificial intelligence model for lightweight are the same.

Meanwhile, a may be a parameter for the weights of the left and right terms. T may be a parameter alleviating the property of the Softmax function that makes a large input value very large and a small input value very small.

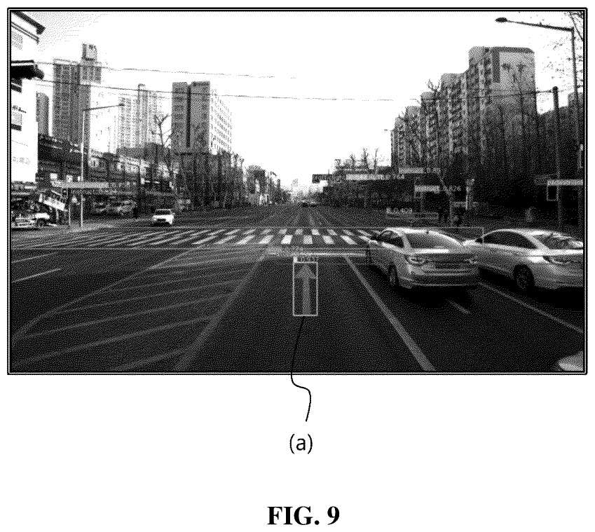

FIGS. 9 to 11 are exemplary views for explaining a facility update method according to an embodiment of the present invention.

As shown in FIG. 9, the data processing device may set a bounding box (a) for an area corresponding to a facility such as a sign, crosswalk, or traffic light inside a received image.

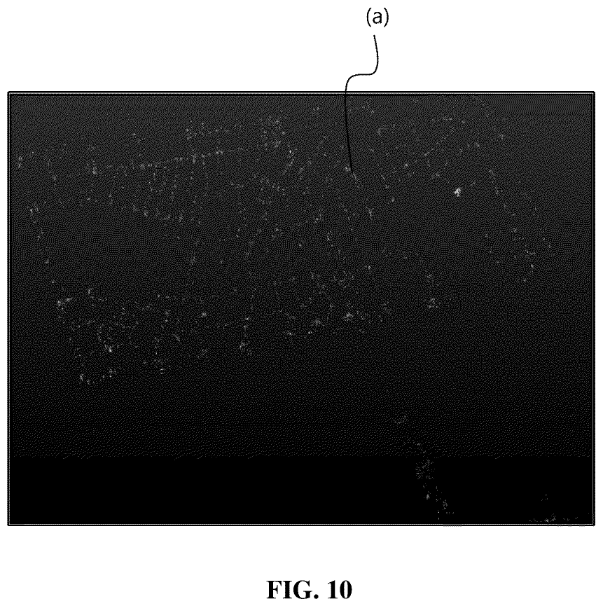

Meanwhile, FIG. 10 is an exemplary view showing a result of collecting point clouds included in a bounding box.

As shown in FIG. 10, the data processing device may collect point clouds included in the bounding box by projecting the point cloud data onto the image.

That is, the data processing device may collect the points included in the bounding box by projecting the point cloud data acquired by the LiDAR through calibration of the camera and the LiDAR onto the image. At this point, the data processing device may accumulate and store the points included in the bounding box for a plurality of images successively received.

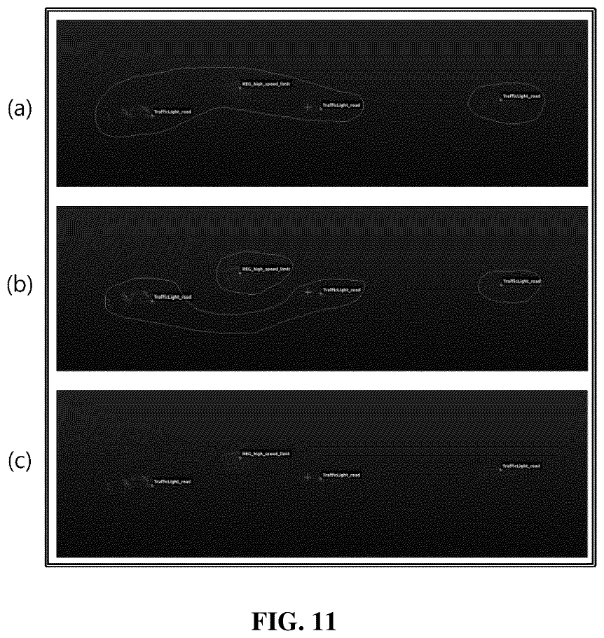

Meanwhile, FIG. 11 is an exemplary view for explaining the process of classifying the collected point cloud.

As shown in FIG. 11 (a), the data processing device may generate at least one first cluster instance by applying a Euclidean clustering algorithm to the collected point clouds. That is, the data processing device may perform clustering on the basis of a Euclidean distance according to the equation shown below.

Thereafter, as shown in FIG. 11 (b), the data processing device may generate at least one second cluster instance on the basis of class names of the points included in the at least one generated first cluster instance, and identify the newly generated second cluster instance as an object. That is, the data processing device may calculate a score value of at least one first cluster instance for each class name, and when the calculated score value is greater than or equal to a preset value, it may be regarded as at least one second cluster instance.

In addition, as shown in FIG. 11 (c), the data processing device may generate at least one third cluster instance for each of the second cluster instances by applying the Euclidean clustering algorithm.

In addition, the data processing device may identify the at least one generated third cluster instance as an object. That is, the data processing device may set a representative point representing each of the third cluster instances, extract coordinates corresponding to the representative point, and identify the coordinates of the object.

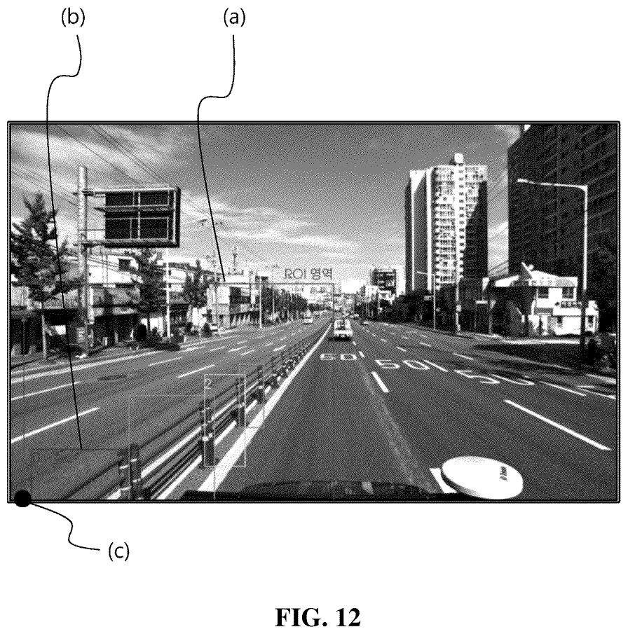

FIGS. 12 to 14 are exemplary views for explaining a facility management method according to an embodiment of the present invention.

As shown in FIG. 12, the data processing device may set a region of interest (a) inside an image. At this point, the data processing device may set a rectangle of a preset size including a specific point (c) located at the bottom left of the image as the bottom left vertex as a region of interest (a).

At this point, the data processing device may set in advance a region of interest on the basis of the x-axis and y-axis coordinates of the image. For example, the data processing device may set a region of interest (a) under the following conditions.

$$50 < w < w / 2 \\ 0 < y < h / 2$$

(Here, w may be the width of a region of interest (a), and h may be the height of the region of interest (a).)

Thereafter, the data processing device may perform segmentation inside the set region of interest (a) and specify at least one bounding box corresponding to an object.

Meanwhile, as the median barrier located at the bottom left in the region of interest (a) is not fully contained in the camera angle, it is captured as an image of a partially truncated form.

Accordingly, when a plurality of bounding boxes is specified in the region of interest, the data processing device may detect a bounding box (b) closest in distance to a specific point (c), and exclude the detected bounding box.

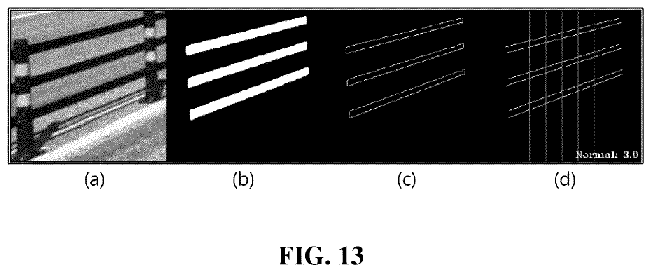

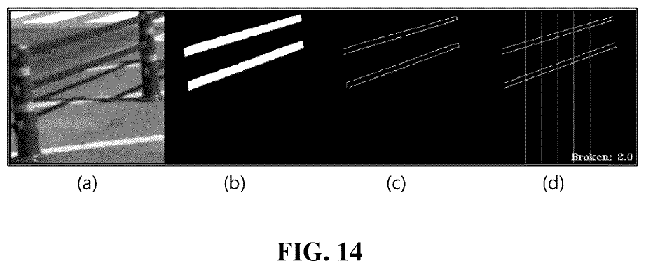

Meanwhile, FIG. 13 is an exemplary view showing a process of detecting an undamaged median barrier, and FIG. 14 is an exemplary view showing a process of detecting a damaged median strip.

As shown in FIG. 13 (a), the median barrier includes three horizontal bars. The data processing device may detect the horizontal bars from the median barrier and determine whether the horizontal bars are damaged.

To this end, as shown in FIG. 13 (b), the data processing device may replace the value of all pixels existing inside the bounding box with a local minimum in order to approach the image from a morphological perspective.

Thereafter, as shown in FIG. 13 (c), the data processing device may derive the intersection points after mapping the pixels existing in the bounding box from the (x, y) coordinate space to the (r, θ) parameter space, and extract an edge corresponding to the component of the straight line on the basis of pixels corresponding to the derived intersection points. That is, the data processing device may detect at least one horizontal bar from the median barrier existing in the bounding box.

Then, the data processing device may generate a plurality of straight lines parallel to each other and formed in the height direction of the bounding box at preset intervals inside the bounding box, and determine whether the image is damaged on the basis of the number of contact points between the extracted edge and the plurality of generated straight lines. That is, the data processing device may generate a plurality of virtual lines parallel to the y-axis of the image and spaced apart from each other by a predetermined distance, and determine whether each horizontal bar is damaged on the basis of the number of contact points in contact with each virtual line of each horizontal bar.

That is, as shown in FIG. 13(d), two contact points are detected per virtual line in each horizontal bar included in the median barrier.

On the other hand, as shown in FIG. 14(d), in the case of a median barrier in which the horizontal bar located at the lowest end among the three horizontal bars is damaged, there is no contact point for the damaged horizontal bar.

Accordingly, the data processing device may identify the number of horizontal bars included in the median barrier on the basis of the number of contact points between the extracted edge and the plurality of generated straight lines, and determine that the median barrier is damaged when the number of horizontal bars is smaller than a preset value.

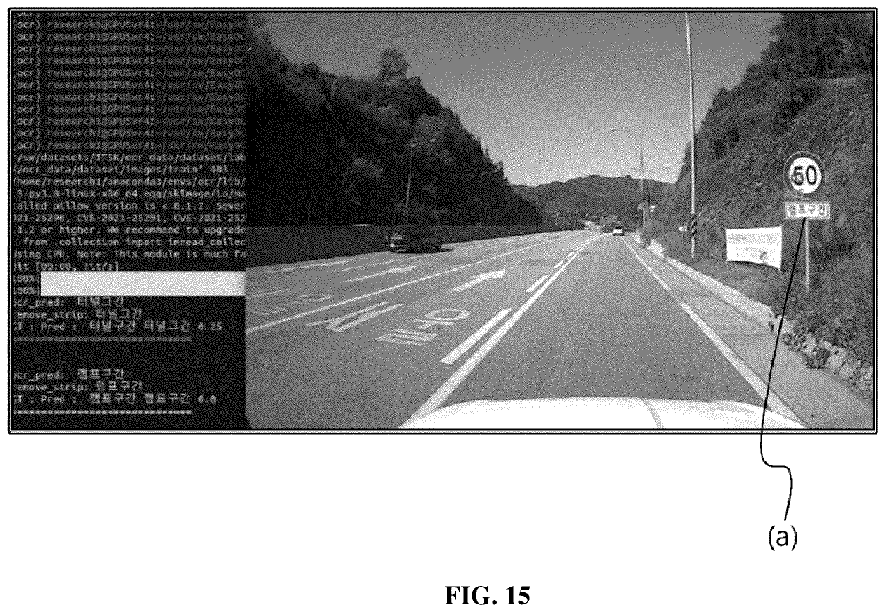

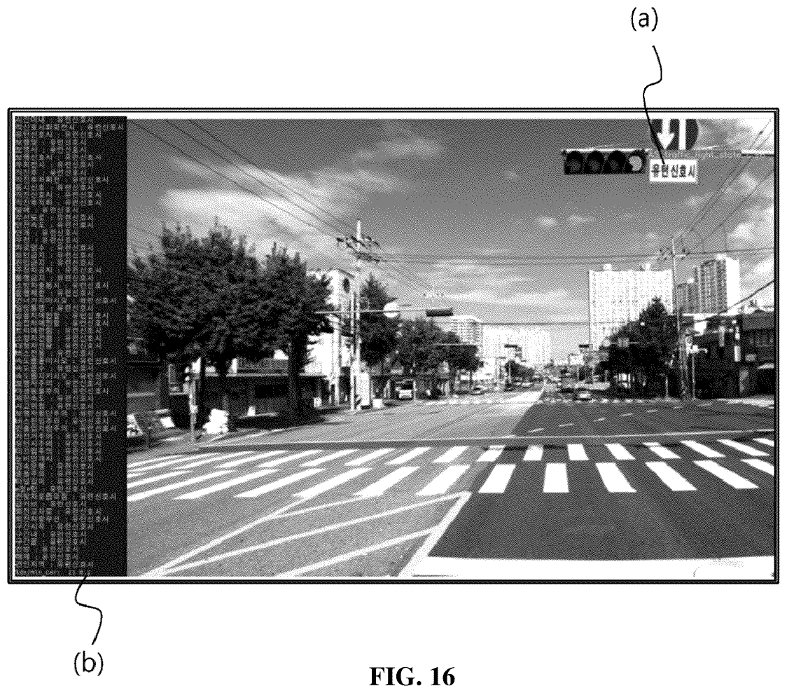

FIGS. 15 and 16 are exemplary views for explaining a facility management method according to another embodiment of the present invention.

As shown in FIG. 15, the data processing device may set a bounding box by detecting a facility (a) in an image captured by a camera mounted on a vehicle traveling on the road, and identify the type of the facility (a) by recognizing text written inside the set bounding box.

That is, the data processing device may recognize “ramp section” included in the facility and identify the type of a corresponding sign.

At this point, the data processing device may recognize text through optical character recognition (OCR).

Then, as shown in FIG. 16, the data processing device may identify the type of a facility corresponding to the identified object on the basis of recognized text “in case of U-turn signal.” That is, the data processing device may identify the type of a facility by comparing the recognized text (a) with a previously stored facility list (b).

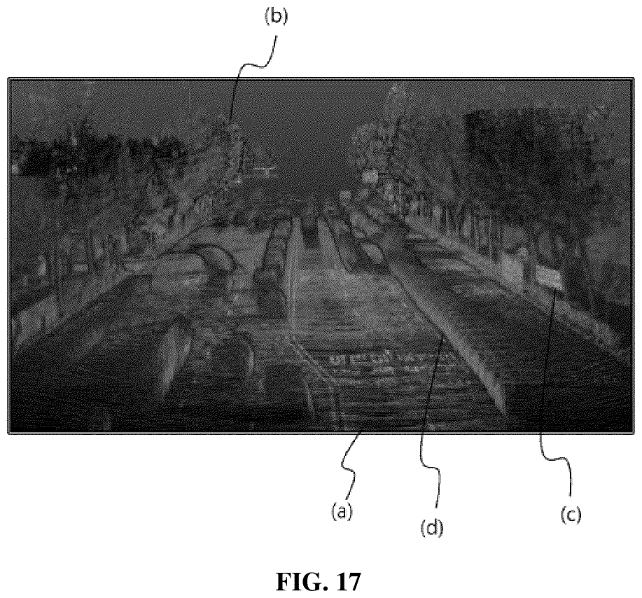

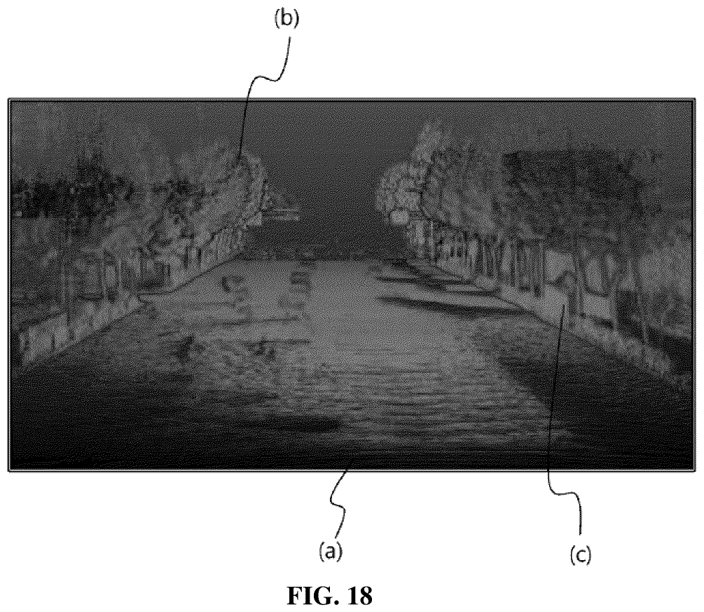

FIGS. 17 and 18 are exemplary views for explaining a noise removing method according to an embodiment of the present invention.

Specifically, FIG. 17 is a point cloud map created using point cloud data to which the noise removal method according to an embodiment of the present invention is not applied, and FIG. 18 is a point cloud map created using point cloud data to which the noise removal method according to an embodiment of the present invention is applied.

As shown in FIG. 17, dynamic objects such as a vehicle (d), as well static objects such as the road (a), trees (b), and facilities (c), are collected on the point cloud map. Here, the vehicle (d) corresponds to noise in a high-definition road map. Therefore, the noise removal method according to an embodiment of the present invention may remove noise such as a vehicle from a map.

To this end, the data processing device may delete a point cloud corresponding to the object identified from the image from the point cloud data, and create a map on the basis of the point cloud data from which a point cloud corresponding to the object is deleted.

As described above, although preferred embodiments of the present invention have been disclosed in the specification and drawings, it is apparent to those skilled in the art that other modified examples based on the technical spirit of the present invention can be implemented in addition to the embodiments disclosed herein. In addition, although specific terms are used in the specification and drawings, they are only used in a general sense to easily explain the technical contents of the present invention and help understanding of the present invention, and are not intended to limit the scope of the present invention. Accordingly, the detailed description described above should not be interpreted as limiting in all respects and should be interpreted illustrative. The scope of the present invention should be selected by reasonable interpretation of the appended claims, and all changes within the equivalent scope of the present invention are included in the scope of the present invention.

DESCRIPTION OF SYMBOLS

| | |
|---|---|
| 100: Data collection device | 200: Data generation device |
| 300: Data processing device | |
| 205: Communication unit | 210: Input/output unit |
| 215: Facility update unit | 220: Facility management unit |
| 225: Noise removal unit | 230: Model lightweight unit |

What is claimed is:

1. A method of lightweighting an artificial intelligence model, the method comprising the steps of:
pruning an artificial intelligence model machine-learned using a first data set, by a data processing device;
quantizing the pruned artificial intelligence model, by the data processing device; and
learning the artificial intelligence model by imitating another artificial intelligence model previously trained using a second data set including a larger amount of data than the first data set, by the data processing device.

2. The method according to claim 1, wherein the pruning step includes converting a corresponding weight to ‘0’ when a weight value of each layer included in the artificial intelligence model is smaller than or equal to a preset value.

3. The method according to claim 2, wherein the pruning step includes analyzing sensitivity of the artificial intelligence model, and determining a threshold for the weight value by multiplying a sensitivity parameter according to the analyzed sensitivity by a standard deviation of a weight value distribution of the artificial intelligence model.

4. The method according to claim 1, wherein the artificial intelligence model is configured as a “floating point 32-bit type”, and the quantizing step includes converting the artificial intelligence model into a “signed 8-bit integer type”.

5. The method according to claim 4, wherein the quantizing step includes quantizing a plurality of weights of the artificial intelligence model, and quantizing activation at a time point of inference.

6. The method according to claim 4, wherein the quantizing step includes quantizing a plurality of weights of the artificial intelligence model, and previously quantizing the plurality of weights and activations of the artificial intelligence model.

7. The method according to claim 4, wherein the quantizing step includes determining a weight and performing quantization at the same time by simulating in advance an effect of applying quantization during inference at a time point when learning of the artificial intelligence model is progressed.

8. The method according to claim 1, wherein the learning step includes calculating a loss by comparing outputs of the artificial intelligence model and another artificial intelligence model, and learning the artificial intelligence model so that the calculated loss is minimized.

9. The method according to claim 1, wherein the artificial intelligence model is an artificial intelligence model for detecting objects on an image captured by the camera.

10. A computer program recorded on a recording medium for executing, in combination with a computing device configured to include a memory, a transceiver, and a processor that processes instructions loaded on the memory, the steps of:
pruning an artificial intelligence model machine-learned using a first data set, by the processor;
quantizing the pruned artificial intelligence model, by the processor; and
learning the artificial intelligence model by imitating another artificial intelligence model previously trained using a second data set including a larger amount of data than the first data set, by the processor.
